(19) United States
(12) Patent Application Publication
(10) Pub. No.: US 2024/0248925 A1
(43) Pub. Date: Jul. 25, 2024

(54) METHOD FOR CLASSIFYING AND USING LEGAL DOCUMENTS

(71) Applicant: Advocatenkantoor Thierry Lauwers bv, Sint-Martens-Latem (BE)

(72) Inventor: Thierry LAUWERS, Sint-Martens-Latem (BE)

(21) Appl. No.: 18/401,993

(22) Filed: Jan. 2, 2024

(30) Foreign Application Priority Data
Dec. 30, 2022 (BE) 20226114

(51) Int. Cl. G06F 16/383; G06F 16/33; G06F 16/35

(52) U.S. Cl. CPC G06F 16/383; G06F 16/3347; G06F 16/35

(57) ABSTRACT

The present invention relates to a computer-implemented method for classifying legal documents comprising the steps of creating a set of labels, assigning a vector representation to each label, clustering the vector representations into hierarchical levels, classifying a legal document using zero-shot classification, wherein the zero-shot classification is performed recursively, wherein in a first recursion only vector representations of a highest hierarchical level are used, wherein in each subsequent recursion only vector representations of a subsequent lower hierarchical level are used for which the zero-shot classification has assigned a score to the vector representation of a previous higher hierarchical level that is above the predetermined first limit value. The invention also relates to a computer system, a computer program product and a computer-readable information carrier.

### TECHNICAL FIELD

The invention relates to a computer-implemented method for classifying and using legal documents, a computer system configured to perform the computer-implemented method, a computer program product comprising instructions for performing the computer-implemented method, and a computer-readable information carrier on which the computer program product is stored.

### PRIOR ART

The Belgian legal system, as well as a number of other legal systems around the world, rely heavily on written legal opinions and the written rulings of judges to explain or interpret laws governing dispute resolution. As a result, judges and lawyers search for the most relevant previous opinions or case law in order to resolve or prevent disputes, while this amount of information continues to increase. Found cases are studied for relevance and are ultimately cited and discussed in documents called procedural materials, which may, for example, advocate legal action, advise clients on likely legal actions, or inform clients and lawyers about laws in certain jurisdictions.

A disadvantage is that these legal documents are not easily searchable and they lack a user-friendly search terminal where the results are ordered according to relevance to the search query. The Boolean search algorithm as according to Google is not very suitable for such ordering, as case law is a dynamic and discontinuous system of laws, rulings, judges and courts, where interpretations of laws can be tied to a zeitgeist, social or societal circumstances, different courts or judges, anticipations of future laws, and so on.

BE1025360 describes a system for managing and using legal/fiscal documents from case law. This system allows legal documents from a collection of legal documents to be automatically sorted based on criteria. However, legal documents can concern very complex matters, meaning that many different criteria can relate to one document. Criteria can also differ very minimally from each other, but still have important legal consequences. Therefore, a disadvantage of this system is that it requires adding a lot of criteria to the system. This means that the system requires a lot of memory to store all documents and their possible criteria. This also means that the system requires enormous computing power if a new legal document must be able to be added to the collection of legal documents in an automated manner, since all the criteria for the new legal document must be evaluated. Another disadvantage is that due to its dynamic and discontinuous nature, new criteria have to be added to the system each time. The system can sort the legal documents based on criteria, but it is still necessary to have the legal documents interpreted by a lawyer or legal expert.

The present invention aims to solve at least some of the above problems or drawbacks.

### SUMMARY OF THE INVENTION

In a first aspect, the present invention relates to a computer-implemented method according to claim 1.

The computer-implemented method has the advantage that less memory is required to store labels and less computing power to assign labels to a legal document in an automated manner. Because the legal document is classified using a zero-shot classification, only a limited number of labels need to be saved in advance as a known classification. Unknown classifications are determined independently by the zero-shot classification system. This also allows changes in case law to be automatically taken into account when classifying, because it is not necessary to manually add possible new classifications. Because the vector representations of the labels are hierarchically clustered and the zero-shot classification is performed recursively, not all known labels for the legal document need to be evaluated. This means that less computing power and time are required to classify a legal document. The computer-implemented method allows a legal document to be classified in a fully automated manner and with efficient use of memory and computing power.

Preferred embodiments of the computer-implemented method are set out in claims 2-13.

A specific preferred form concerns a computer-implemented method according to claim 6.

This preferred form has the advantage that a model is trained that allows the automatic extraction of important features from legal documents based on a type of plaintiff, defendant or a combination thereof. This allows a layperson to know, for a legal case in which the layperson is involved as plaintiff or defendant, the features that will be important for their legal case when determining a verdict, which allows even a layperson to estimate their chances of success in their legal case without consulting the legal documents.

In a second aspect, the present invention relates to a computer system according to claim 14.

This computer system has the advantage that legal documents can be automatically classified and used with less memory, computing power and computing time.

In a third aspect, the present invention concerns a computer program product according to claim 15.

This computer program product has the advantage that, when executed on a computer system, legal documents can be automatically classified and used with less memory, computing power and computing time.

In a fourth aspect, the present invention relates to a computer-readable information carrier according to claim 16.

The computer-readable information carrier is advantageous for installing a computer program product on a computer system so that when the computer program product is executed on the computer system, legal documents can be automatically classified and used with less memory, computing power and computing time.

### DESCRIPTION OF THE FIGURES

FIG. 1 shows a schematic representation of a computer-implemented method according to an embodiment of the present invention.

### DETAILED DESCRIPTION

Unless otherwise defined, all terms used in the description of the invention, including technical and scientific terms, have the meanings as commonly understood by a person skilled in the art to which the invention pertains. For a better understanding of the description of the invention, the following terms are explained explicitly.

In this document, “a” and “the” refer to both the singular and the plural, unless the context presupposes otherwise. For example, “a segment” means one or more segments.

The terms “comprise,” “comprising,” “consist of,” “consisting of,” “provided with,” “include,” “including,” “contain,” “containing,” are synonyms and are inclusive or open terms that indicate the presence of what follows, and which do not exclude or prevent the presence of other components, characteristics, elements, members, steps, as known from or disclosed in the prior art.

In the context of this document, “word embedding” refers to a technique for representing a word as a vector of real numbers. Non-limiting examples of word embeddings are one-hot encoding, TF-IDF transformation, co-occurrence matrix, a neural probabilistic model, word2vec, Continuous Bag-of-Words (CBOW), Continuous Skip-Gram, GloVe, FastText, Pincare Embeddings, ELMo and Probabilistic FastText.

In a first aspect, the invention concerns a computer-implemented method for classifying and using legal documents.

According to a preferred embodiment, the computer-implemented method comprises the steps of:
creating a set of labels;
assigning a vector representation to each label from the set of labels using word embedding;
classify a legal document using zero-shot classification.

A label is a word or several words, preferably at most 10 words, more preferably at most 5 words and even more preferably at most 3 words, that characterizes the legal document. A label can, but does not have to, literally appear in a legal document. Based on labels assigned to a legal document, a person receives a content summary of the legal document and a person can assess whether the legal document is relevant to a particular legal case. Preferably, the set of labels includes multiple natural languages.

Assigning a vector representation to each label in the set is advantageous for automatically classifying legal documents using a computer system. A computer system is not suitable for interpreting natural languages but can handle vectors very well. The label and its vector representation form a pair, where the label is in natural language and can be interpreted by a person and the vector representation can be interpreted by the computer system. Preferably both are stored in the set of labels.

To classify the legal document using zero-shot classification, the vector representations are clustered into hierarchical levels. This means that there is a highest hierarchical level with a limited number of vector representations. Each vector representation at the highest hierarchical level can be linked to one or more vector representations at a subsequent underlying hierarchical level, which in turn can be linked to one or more vector representations at an even lower underlying hierarchical level. Referring to the corresponding labels, this means that lower hierarchical levels make a more detailed classification. For example, the vector representation of the tax label could be included in a highest hierarchical level, while the vector representations of the personal income tax and corporate income tax labels could be included in a subsequent underlying hierarchical level. The clustering into hierarchical levels forms a tree structure, so to speak. The clustering is preferably done in an automated manner. A non-limiting example of a suitable clustering is HDBSCAN (Hierarchical Density-Based Spatial Clustering of Applications with Noise).

Zero-shot classification is known from the prior art for processing natural languages. Classifying the legal documents using the zero-shot classification is advantageous because a document can be classified not only on the basis of known classifications, but also on the basis of unknown classifications. The unknown classifications are determined based on known classifications and/or context in the legal document. Because the legal document is classified using a zero-shot classification, only a limited number of labels need to be saved in advance as a known classification. This means less memory is required. Unknown classifications are determined independently by the zero-shot classification system. This also allows changes in case law to be automatically taken into account when classifying, so that it is not necessary to manually add possible new classifications.

The vector representations of the labels from the set of labels are used as known classifications in the zero-shot classification. The zero-shot classification assigns a score to every known classification and every unknown classification. This score is a measure of content similarity with the legal document.

The zero-shot classification is performed recursively. In a first recursion, only vector representations of a highest hierarchical level are used. In each subsequent recursion, only vector representations of a subsequent lower hierarchical level are used for which the zero-shot classification has assigned a score to the vector representation of a previous higher hierarchical level that is above a predetermined first limit value. For example, in the first recursion, the vector representation of the tax label is assigned a score above the first limit value. Only in a second recursion are the vector representations of the labels, personal income tax and corporate income tax used as known classifications. For example, if the vector representation of the personal income tax label is assigned a score that is again higher than the first limit value and corporate income tax is assigned a score that this time is lower than the first limit value, in a third recursion, the vector representations of the labels that are associated with personal income tax in a subsequent underlying hierarchical level will be used as known classifications, while this will not happen for the labels that are associated with corporate income tax in the subsequent underlying hierarchical level. The zero-shot classification stops once no more vector representations of a hierarchical level are assigned a score higher than the first limit value.

For each known classification and each unknown classification that is assigned a score above the predetermined first limit value by the zero-shot classification, the legal document is assigned a label associated with one of these known classifications or unknown classifications. For the known classifications, this is the label from the pair of label and vector representation. For unknown classifications, this is a text that corresponds to the vector representation of the unknown classification. The vector representation of the labels associated with the unknown classifications are assigned using the same word embedding as for the labels from the set of labels. Thus, in the preceding example, the labels tax and personal income tax would be assigned to the legal document.

Because the vector representations of the labels are hierarchically clustered and the zero-shot classification is performed recursively, not all known labels for the legal document need to be evaluated. This means that less computing power and time are required to classify a legal document. The computer-implemented method allows a legal document to be classified in a fully automated manner and with efficient use of memory and computing power.

According to a preferred embodiment, the legal document is divided into fragments of a predetermined number of words. The zero-shot classification is performed on each fragment separately. When dividing, sections or logical blocks of text are not taken into account.

This embodiment is particularly advantageous to avoid assigning many labels to a legal document. Legal documents, such as judgments, are very complex and discuss many aspects of legislation, including why a certain aspect of legislation does not apply. If the zero-shot classification were to be performed on an entire legal document, many labels would be assigned to the legal document that are not actually relevant, for example the sections that explain why a certain aspect of the law is not applicable or a certain aspect that appears to a limited extent in the entire legal document and is therefore awarded a high score, but is not the core of the legal document. To avoid this it is necessary to determine a large first limit value in advance. The risk is that as a result relevant labels are not assigned to the legal document because this aspect is only discussed in a limited number of places in the legal document. In both cases there is a real risk that a more or less uniform score is assigned to all known and unknown classifications. By dividing the legal document into fragments, a lower first limit value can be determined and it is possible to score the most relevant known and unknown classifications high per fragment. In addition, assigning a more or less uniform score to all known and unknown classifications is avoided. An additional advantage is that this also saves on working memory, computing power and computing time. Only a limited portion of the legal document must be loaded into memory and processed each time. Because more or less uniform scores are not assigned to all known and unknown classifications, a higher first limit value can also be determined, which means that fewer recursive steps have to be performed in each fragment.

According to a further embodiment, separate scores assigned to the known and unknown classifications in the fragments are summed. This allows an overall score to be assigned to the known and unknown classifications for the entire legal document. This is particularly advantageous to achieve an even better assignment of labels to the legal document. Preferably, a predetermined second limit value is used, where every known and unknown classification whose summed score is above the predetermined second limit value is assigned to the legal document. It will be apparent to one skilled in the art that the individual scores can be added up according to a formula.

According to a preferred embodiment, labels assigned to the legal document are added to the set of labels. Clearly, this practically concerns the labels associated with unknown classifications, since the labels associated with the known classifications are already included in the set of labels. This is advantageous because it means that more known classifications are included and the zero-shot classification can be better controlled. Preferably, a label is added to the set of labels if the label is assigned to a number of legal documents, wherein this number exceeds a predetermined third limit value. This is advantageous because it prevents a label from being immediately added to the set of labels, while the legal document, for example, concerns an unrepresentative judgment or an incorrectly assigned label.

According to a preferred embodiment, the legal document and the assigned labels are stored in a database. The database is, for example, a database on a server or a computer. This embodiment is advantageous because it makes the legal document and the labels assigned to it available for further use, for example for finding relevant legal documents or, as in further described embodiments, for determining the chances of success in a legal case.

According to a further embodiment, supervised training of a model for extracting important features from legal documents takes place using legal documents from the database. The important features are based on the labels assigned to the legal documents. The legal documents are a selection from the database based on a type of plaintiff, a type of defendant or a combination thereof. For example, the plaintiff is a government, such as a government tax collection agency. For example, the defendant is a natural person or a legal entity. It is clear that if there is only one type of plaintiff or one type of defendant, there is no need for explicit selection based on the type of plaintiff or type of defendant, respectively. It will also be apparent that additional criteria can be used to select the legal documents, such as whether it concerns a criminal case or a civil case. The legal documents are at least classified in advance into legal cases that have been won or lost. Won or lost is from the standpoint of the plaintiff. The classification into won or lost legal cases ensures that the training is supervised. The classification can be done manually or automatically.

The model for extracting important features from legal documents is advantageous for determining those features that determine whether a legal case can be successfully concluded or for predicting whether a legal case, based on its most important features, can be successfully concluded or not. For example, the model can be a tree structure, wherein the most important features are located closer to the root of the tree structure and wherein each branch ends with a percentage chance of successfully concluding the legal case.

According to a further embodiment, the classification into cases that have been won or lost is done automatically on the basis of keywords in the legal documents. For example, this is done on the basis of the presence of the keywords “upheld” and “not upheld” in a court judgment. “Upheld” appears in almost every judgment to indicate that a claim made by a plaintiff has been granted, indicating that the plaintiff has won the legal case. “Not upheld” means that the plaintiff's claim has been rejected and that the plaintiff has lost the legal case. This embodiment is advantageous because it allows large amounts of legal documents to be used for training the model without human intervention.

According to a preferred embodiment, the legal document is anonymized automatically. This means that at least all names of natural persons, names of legal entities, company numbers, settlement amounts, and all other possible data that could lead to the identification of parties in the legal case are removed from the legal document. As a result, the anonymized legal documents are in accordance with applicable privacy regulations, such as the GDPR regulations (General Data Protection Regulation) applicable in Europe. The legal document is anonymized before or after classification. The anonymized legal document can then be consulted in a database together with labels assigned to the legal document. The database is, for example, a database on a server or a computer. The database may be the same database as the database of a previously described embodiment that stores the legal document and assigned labels. The database can also be a different database. Preferably the database is the same database.

It will be apparent that if the legal document is anonymized before classification, the labels are assigned to the anonymized legal document and that if the legal document is anonymized after classification, the labels assigned to the legal document before anonymization will also be assigned to the anonymized legal document, with the exception of any labels that could again lead to identification of parties.

Removing this data is preferably done using a combination of named-entity recognition (NER), regular expressions (Regex) and part-of-speech (POS) tagging. The applicant determined that the use of NER alone was insufficient to anonymize legal documents.

For example, the legal document can be uploaded to a platform by a court clerk, after which the legal document is automatically anonymized and made available to the public in the database as case law.

According to a preferred embodiment, parties are identified automatically from the legal document. For this purpose, an extraction and linking engine is used, which extracts names of parties from the legal document and links them to their roles, for example judge, plaintiff, defending party, plaintiff's lawyer, defending party's lawyer, etc., in a legal case. This embodiment is performed in combination with a previously described embodiment in which the legal document is anonymized, before or simultaneously with the anonymization. In combination with anonymization, the identified parties cannot be consulted in the database with anonymized legal documents.

This embodiment is advantageous because rulings in legal cases may depend on a judge's interpretation. Certain lawyers may also be more successful than other lawyers. A lawyer's chance of success may also depend on whether the lawyer is the plaintiff or the defending party. Information about a plaintiff or a defending party is useful to estimate how aggressive a party is in legal matters and how successful a party is.

According to a preferred embodiment, the model for extracting important features in legal documents is used in a chat application. The chat application is used at a first end by a user involved in a legal case. The chat application is used by a bot at a second end. In the chat application, the bot asks the user questions using natural language generation. Non-limiting examples of suitable models for natural language generation are GPT-3, LaMDA and Wu-Dao. The questions are preferably questions that can be answered with yes or no or multiple choice questions. The user's answers are interpreted using natural language interpretation. The questions are focused on the most important features of a legal case in which the user is an involved party. The most important features are selected by the chat application using the model for extracting important features based on a type of plaintiff, a type of defendant, or a combination thereof. For example, the plaintiff type is a government tax collection agency and the defendant type is a corporation. Based on the model, the chat application will then ask an initial question about a feature of the legal case that is the most important feature for such a legal case. For example, if the model is a tree structure, the feature that is closest to the root of the tree structure for the plaintiff type, the defendant type or the plaintiff and defendant types. This embodiment is advantageous for selecting the most relevant legal documents for the user's legal case. This embodiment is also advantageous for determining, for example, which employee in a legal office is most appropriate to assist the user of the chat application.

In addition to the type of plaintiff, a type of defendant and a combination thereof, the most important features can also be selected on the basis of a type of claim or a combination with one of the above. It is clear the invention is not limited to the currently listed types.

According to a further embodiment, each subsequent question in the chat application is automatically determined based on an answer to a previous question using the model for extracting important features. In the previous example where the model is a tree structure, this means that the tree structure is traversed from the root to the end of a branch of the tree structure. This embodiment is advantageous for quickly and automatically selecting the most relevant legal documents and/or for determining the most appropriate employee in the legal office.

According to a preferred embodiment, the chat application automatically calculates a chance of success in the legal case. To this end, the chat application uses the model for extracting important features from legal models. Based on the most important features of the user's legal case, it is possible to select the most relevant legal documents from the database. For each of the most relevant legal documents it is known whether the legal case has been won or lost and a chance of success in the legal case can therefore be calculated. If the model is a tree structure, then the probability of success is a percentage chance of successfully concluding the legal case at the end of each branch.

This embodiment is very advantageous because it allows to quickly assess whether there is sufficient chance of winning the legal case or whether it is better to settle the matter as quickly as possible. This allows a user to close their legal case as cost-efficiently as possible.

According to a further embodiment, parties in the legal case are taken into account when calculating a chance of success in the legal case. The parties are, for example, a judge assigned to the legal case, a plaintiff, a defending party, an attorney for the plaintiff, and an attorney for the defending party.

Rulings in legal cases may depend on an interpretation by a judge. Certain lawyers may also be more successful than other lawyers. A lawyer's chance of success may also depend on whether the lawyer is the plaintiff or the defending party. Information about a plaintiff or a defending party is useful to estimate how aggressive a party is in legal matters and how successful a party is. These elements can usefully contribute to estimating the chance of success. It is clear that this embodiment can be advantageously combined with a previously described embodiment in which parties are identified automatically from the legal document.

According to a preferred embodiment, the legal document is used to train a natural language generation model. Preferably, the model is trained with multiple legal documents. Non-limiting examples of suitable models for natural language generation are GPT-3, LaMDA and Wu-Dao. Preferably, the model is trained using multiple anonymized legal documents. This embodiment can therefore be advantageously combined with a previously described embodiment wherein the legal document is automatically anonymized. Preferably, the natural language generation model is retrained after each additional anonymized legal document.

This embodiment is advantageous for obtaining a natural language generation model that is able to assist in the preparation of legal documents or for the independent preparation of legal documents.

According to a preferred embodiment, the model for extracting important features in legal documents is used in a chat application. The chat application is used at a first end by a user ruling in a legal case. The user is therefore preferably a judge. The chat application is used by a bot at a second end. In the chat application, the bot asks the user questions using natural language generation. Non-limiting examples of suitable models for natural language generation are GPT-3, LaMDA and Wu-Dao. The questions are preferably questions that can be answered with yes or no or multiple choice questions. The user's answers are interpreted using natural language interpretation. The questions are aimed at the most important features of a legal case in which the user judges. The most important features are selected by the chat application using the model for extracting important features based on a type of plaintiff, a type of defendant, a type of claim, or a combination thereof. It is clear the invention is not limited to the currently listed types. For example, the plaintiff type is a government tax collection agency and the defendant type is a corporation. Based on the model, the chat application will then ask an initial question about a feature of the legal case that is the most important feature for such a legal case. For example, if the model is a tree structure, the feature that is closest to the root of the tree structure for the type of plaintiff, the type of defendant, the type of claim or a combination thereof.

Each subsequent question in the chat application is automatically determined based on an answer to a previous question using the model for extracting important features. In the previous example where the model is a tree structure, this means that the tree structure is traversed from the root to the end of a branch of the tree structure.

The chat application determines an outcome in the legal case. To this end, the chat application uses the model for extracting important features from legal models. Based on the most important features of the legal case, it is possible to select the most relevant legal documents from the database. For each of the most relevant legal documents it is known whether the legal case has been won or lost and it can therefore be determined how the legal case should be sentenced according to case law. If the model is a tree structure, then the method of sentencing is determined at the end of each branch.

Using a natural language generation model, the chat application writes a judgment based on the answers given by the user and the outcome determined by the chat application. The natural language generation model is preferably a model trained using legal documents, as in a previously described embodiment.

This embodiment is very advantageous because it allows a user, in this case a judge, to quickly draw up a judgment in the legal case that is consistent with case law.

In a second aspect, the invention relates to a computer system comprising a processing unit configured to perform a computer-implemented method according to the first aspect.

This computer system has the advantage that legal documents can be automatically classified and used with less memory, computing power and computing time.

In a third aspect, the invention relates to a computer program product comprising instructions, when executed by a computer system, causing the computer system to perform a computer-implemented method according to the first aspect.

This computer program product has the advantage that, when executed on a computer system, legal documents can be automatically classified and used with less memory, computing power and computing time.

In a fourth aspect, the invention relates to a computer-readable information carrier on which a computer program product according to the third aspect is stored. The computer-readable information carrier can be a hard disk, a CD, a DVD, a USB stick or another suitable information carrier.

The computer-readable information carrier is advantageous for installing a computer program product on a computer system so that when the computer program product is executed on the computer system, legal documents can be automatically classified and used with less memory, computing power and computing time.

In what follows, the invention is described by means of a non-limiting FIGURE illustrating the invention, and which is not intended to or should not be construed as limiting the scope of the invention.

### DESCRIPTION OF THE FIGURES

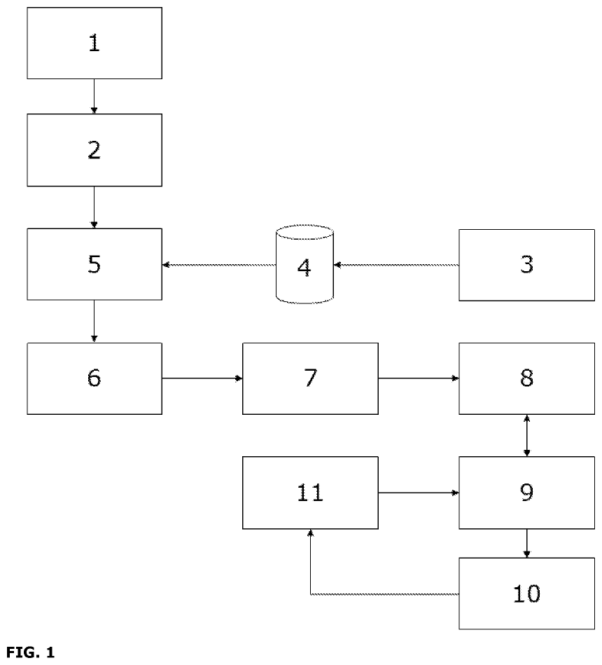

FIG. 1 shows a schematic representation of a computer-implemented method according to an embodiment of the present invention.

In a first step (1), a legal document is loaded into a database. The legal document in this case is a judgment. In a second step (2), the legal document is anonymized for privacy reasons. It is clear that in the second step (2) when anonymizing the legal document, a plaintiff type and a defendant type if available are added as additional data in the database. In a third step (3), which can be performed before, simultaneously with or after the second step (2), a set of labels is created. In a subsequent fourth step (4), the set of labels is stored in a database. The database may, but does not have to, be the same database as the legal document database. In the fourth step (4), a vector representation is also assigned to each label from the set of labels using word embedding. The vector representations are clustered into hierarchical levels. The label and its vector representation are stored as a pair in the database. After the second step (2) and the fourth step (4) have been performed, the legal document is classified in a fifth step (5) using zero-shot classification. This means that the legal document is assigned labels associated with known or unknown classifications that have been assigned scores higher than a predetermined first limit value by the zero-shot classification. The zero-shot classification is performed recursively. In a first recursion, only vector representations of a highest hierarchical level are used. In each subsequent recursion, only vector representations of a subsequent lower hierarchical level are used for which the zero-shot classification has assigned a score to the vector representation of a previous higher hierarchical level that is above the predetermined first limit value. After the zero-shot classification, the legal document and the labels assigned to it are stored in a database in a sixth step (6). This can, but does not have to, be the same database from the first step (1). In a seventh step (7), the legal document is automatically classified into legal cases that have been won or legal cases that have been lost, based on keywords in the legal document. In an eighth step (8), a model for extracting important features from legal documents is trained. Obviously, this requires storing multiple legal documents with labels assigned to them in the database from step (6). The first step (1), the second step (2), the fifth step (5), the sixth step (6) and the seventh step (7) will therefore necessarily have to be completed separately for several individual legal documents to be able to perform the eighth step (8). The third step (3) and the fourth step (4) may or may not be performed again. Training the model is a supervised training, where the legal documents are at least classified in advance into legal cases that have been won or lost. To train the model, a selection of legal documents from the database is made based on a type of plaintiff or defendant or a combination of both. It is clear that if there is only one type of plaintiff or one type of defendant, this selection does not have to be done explicitly. In a ninth step (9), the model is used to ask questions to a user involved in a legal case. The questions are focused on the most important features of the legal case. The questions are converted into natural language understandable to the user in a tenth step (10) using natural language creation and displayed to the user in an eleventh step (11) in the chat application. The user answers the asked question in the eleventh step (11), which is then interpreted in the ninth step (9). In the ninth step, based on the model for extracting important features and based on the type of plaintiff, the type of defendant or a combination thereof, a next most important feature is selected to be queried, after which the tenth step (10) and the eleventh step (11) must once again be completed. This continues until, for example, if the model is a tree structure, the end of a branch is reached. After this, a chance of success in the legal case can be calculated in the ninth step (9) and can be displayed to the user of the chat application through the tenth step (10) in the eleventh step (11).

1. Computer-implemented method for classifying and using legal documents comprising the steps of:
creating a set of labels;
assigning a vector representation to each label from the set of labels using word embedding;
classifying a legal document using zero-shot classification, wherein the vector representations are used as known classifications, and wherein for each known classification and each unknown classification to which a score is assigned by the zero-shot classification that is above a predetermined first limit value, a label associated with one of these known or unknown classifications is assigned to the legal document;
characterized in that before classifying the legal document the vector representations are clustered into hierarchical levels, wherein the zero-shot classification is performed recursively, wherein in a first recursion only vector representations of a highest hierarchical level are used, wherein in each subsequent recursion only vector representations of a subsequent lower hierarchical level are used for which the zero-shot classification has assigned a score to the vector representation of a previous higher hierarchical level that is above the predetermined first limit value.

2. The computer-implemented method according to claim 1, characterized in that the legal document is divided into fragments of a predetermined number of words, where the zero-shot classification is performed on each fragment separately.

3. The computer-implemented method according to claim 2, characterized in that individual scores assigned to the fragments are added together.

4. The computer-implemented method according to claim 1, characterized in that labels assigned to the legal document are added to the set of labels.

5. The computer-implemented method according to claim 1, characterized in that the legal document and the assigned labels are stored in a database.

6. The computer-implemented method according to claim 5, characterized in that supervised training of a model for extracting important features from legal documents takes place using legal documents from the database, where the legal documents are a selection from the database based on a type of plaintiff, a type of defendant or a combination thereof and where the legal documents are at least classified in advance into legal cases that have been won or lost.

7. The computer-implemented method according to claim 6, characterized in that the classification into legal cases that have been won or lost is done automatically on the basis of keywords in the legal documents.

8. The computer-implemented method according to claim 6, characterized in that the model for extracting important features is used in a chat application, where a user is asked questions using natural language generation in the chat application, where the questions are focused on the most important features of a legal case in which the user is an involved party and wherein the most important features are selected by the chat application based on a type of plaintiff, a type of defendant or a combination thereof using the model for extracting important features.

9. The computer-implemented method according to claim 8, characterized in that each subsequent question in the chat application is automatically determined based on an answer to a previous question using the model for extracting important features.

10. The computer-implemented method according to claim 8, characterized in that the chat application automatically calculates a chance of success in the legal case.

11. The computer-implemented method according to claim 1, characterized in that the legal document is automatically anonymized before or after classification, after which the anonymized legal document can be consulted in a database together with labels assigned to the legal document.

12. The computer-implemented method according to claim 1, characterized in that the legal document is used for training a model for natural language generation.

13. The computer-implemented method according to claim 9, characterized in that the user is a user who has to give a judgment in the legal case and in that the chat application, using a natural language generation model, writes a judgment for the legal case based on the answers given by the user and an outcome determined by the chat application.

14. Computer system comprising a processing unit configured to perform a computer-implemented method according to claim 1.

15. Computer program product comprising instructions, when executed by a computer system, causing the computer system to carry out a computer-implemented method according to claim 1.

16. Computer-readable information carrier on which a computer program product according to claim 15 is stored.
